(19) United States
(12) Patent Application Publication
(10) Pub. No.: US 2026/0170769 A1
(43) Pub. Date: Jun. 18, 2026

(54) AUGMENTED REALITY PICTURE PROCESSING METHOD AND APPARATUS, AND ELECTRONIC DEVICE AND STORAGE MEDIUM

(71) Applicant: Beijing Zitiao Network Technology Co., Ltd., Beijing (CN)

(72) Inventor: Xubin ZHOU, Beijing (CN)

(21) Appl. No.: 19/125,119

(22) PCT Filed: Oct. 19, 2023
(86) PCT No.: PCT/CN2023/125332

§ 371 Date: Apr. 28, 2025

(30) Foreign Application Priority Data
Oct. 28, 2022 (CN) 202211338450.2

(51) Int. Cl. G06T 19/00; G06T 17/10; G06T 19/20

(52) U.S. Cl. CPC G06T 19/006; G06T 17/10; G06T 19/20; G06T 2219/2004

(57) ABSTRACT

A method for augmented reality image processing and apparatus, and an electronic device and a storage medium are disclosed. The method includes: in response to a rendering trigger request for an augmented reality image, displaying, in the augmented reality image, a three-dimensional model of a linear object corresponding to the augmented reality image; and in response to a display adjustment operation for the linear object, displaying an adjusted three-dimensional model of the linear object in the augmented reality image.

This application claims priority to Chinese Patent Application No. 202211338450.2, filed with the China National Intellectual Property Administration on Oct. 28, 2022, the disclosure of which is incorporated herein by reference in its entirety.

### FIELD

Embodiments of the present disclosure relate to a computer technology, and for example, to a method and apparatus, and an electronic device and a storage medium for augmented reality image processing.

### BACKGROUND

An Augmented Reality (AR) technology is a technology that obtains a real world image by photographing a real world in real time and stacks virtual information on the real world image.

### SUMMARY

The present disclosure provides a method and apparatus, and an electronic device and a storage medium for augmented reality image processing.

In a first aspect, the embodiments of the present disclosure provide a method for augmented reality image processing. The method includes:
in response to a rendering trigger request for an augmented reality image, displaying, in the augmented reality image, a three-dimensional model of a linear object corresponding to the augmented reality image; and
in response to a display adjustment operation for the linear object, displaying an adjusted three-dimensional model of the linear object in the augmented reality image, wherein display adjustment operation includes at least one of a display position adjustment operation, a display size adjustment operation, or a display angle adjustment operation.

In a second aspect, the embodiments of the present disclosure further provide an apparatus for augmented reality image processing. The apparatus includes:
a requesting module, configured to: in response to a rendering trigger request for an augmented reality image, display, in the augmented reality image, a three-dimensional model of a linear object corresponding to the augmented reality image; and
a display module, configured to: in response to a display adjustment operation for the three-dimensional model, displaying an adjusted three-dimensional linear object in the augmented reality image, wherein the display adjustment operation includes at least one of a display position adjustment operation, a display size adjustment operation, or a display angle adjustment operation.

In a third aspect, the embodiments of the present disclosure provide an electronic device. The electronic device includes:
one or more processors; and
a storage apparatus, configured to store one or more programs,
wherein the one or more programs, when run by the one or more processors, cause the one or more processors to perform the method for augmented reality image processing provided in any of the embodiments of the present disclosure.

In a fourth aspect, the embodiments of the present disclosure further provide a storage medium including computer-executable instructions. When executed by a computer processor, causing the computer processor to perform the method for augmented reality image processing described in any of the embodiments of the present disclosure.

### BRIEF DESCRIPTION OF THE DRAWINGS

Throughout the accompanying drawings, identical or similar reference numerals represent identical or similar elements. It should be understood that the accompanying drawings are illustrative, and components and elements may not necessarily be drawn to scale.

FIG. 1 is a flowchart of a method for augmented reality image processing according to an embodiment of the present disclosure;

FIG. 2 is a flowchart of a method for augmented reality image processing according to an embodiment of the present disclosure;

FIG. 3 is a flowchart of a method for augmented reality image processing according to an embodiment of the present disclosure;

FIG. 4 is a flowchart of a method for augmented reality image processing according to an embodiment of the present disclosure;

FIG. 5 is a flowchart of a method for augmented reality image processing according to an embodiment of the present disclosure;

FIG. 6A is an example graph of rendering of a three-dimensional model of a linear object in a method for augmented reality image processing according to an embodiment of the present disclosure;

FIG. 6B is an example graph of rendering of a three-dimensional model of a linear object in another method for augmented reality image processing according to an embodiment of the present disclosure;

FIG. 7 is an example graph of a flow of obtaining key points of a linear object in a method for augmented reality image processing according to an embodiment of the present disclosure;

FIG. 8 is an example graph of a triangular primitive on a cross section of a three-dimensional model of a linear object in a method for augmented reality image processing according to an embodiment of the present disclosure;

FIG. 9 is an example graph of a triangular primitive on a connecting surface of a three-dimensional model of a linear object in a method for augmented reality image processing according to an embodiment of the present disclosure;

FIG. 10 is an example graph of intermittent rendering of a three-dimensional model of a linear object in another method for augmented reality image processing according to an embodiment of the present disclosure;

FIG. 11 is a schematic structural diagram of an apparatus for augmented reality image processing according to an embodiment of the present disclosure; and

FIG. 12 is a schematic structural diagram of an electronic device provided according to an embodiment of the present disclosure.

### DETAILED DESCRIPTION OF EMBODIMENTS

Two-dimensional lines are used to enrich and assist augmented reality images. Namely, the two-dimensional lines are drawn on the augmented reality images. However, this processing mode often makes the lines in the augmented reality images appear stiff and lack a sense of three dimensionalities, thereby affecting the image display quality. Moreover, in general, a display mode for the two-dimensional lines is relatively fixed to a display mode for the images, which cannot meet the personalized interaction needs of users well and affects the user experience.

To cope with the above situation, the embodiments of the present disclosure provide a method and apparatus, and an electronic device and a storage medium for augmented reality image processing.

The embodiments of the present disclosure will be described below with reference to the accompanying drawings. Although the accompanying drawings show some embodiments of the present disclosure, it should be understood that the present disclosure can be implemented in various forms, and should not be explained as being limited to the embodiments stated herein. Rather, these embodiments are provided for understanding the present disclosure more thoroughly and completely. It should be understood that the accompanying drawings and embodiments of the present disclosure are only used for illustration, but are not intended to limit the protection scope of the present disclosure.

It should be understood that various steps recorded in method implementations of the present disclosure can be executed in different orders and/or in parallel. In addition, the method implementations may include additional steps and/or omit the execution of the steps shown. The scope of the present disclosure is not limited in this aspect.

The term “include” and its variants as used herein mean widespread inclusion, namely, “including but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

It should be noted that the concepts such as “first” and “second” mentioned in the present disclosure are only used to distinguish different apparatuses, modules, or units, and are not intended to limit the order or interdependence of the functions performed by these apparatuses, modules, or units.

It should be noted that the modifications of “one” and “plurality” mentioned in the present disclosure are indicative rather than restrictive, and those skilled in the art should understand that unless otherwise explicitly stated in the context, they should be understood as “one or more”.

Messages or names of information interacted between a plurality of apparatuses in the implementations of the present disclosure are only for illustrative purposes and are not intended to limit the messages or the scope of the information.

It can be understood that before use of the various embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the embodiments of the present disclosure according to the prompt information.

As an alternative but non-restrictive implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

It can be understood that the above notification and the above user authorization obtaining process are only illustrative and do not constitute a limitation on the implementations of the present disclosure. Other methods that meet the relevant laws and regulations can also be applied to the implementations of the present disclosure.

It can be understood that data involved in this embodiment (including but not limited to the data itself, and obtaining or use of the data) should comply with the requirements of corresponding laws and regulations and relevant provisions.

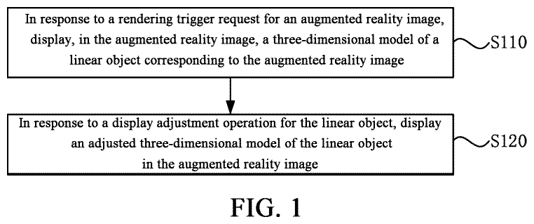

FIG. 1 is a flowchart of a method for augmented reality image processing according to an embodiment of the present disclosure. This embodiment of the present disclosure is applicable to rendering an augmented reality image. The method can be performed by an apparatus for augmented reality image processing. The apparatus can be implemented in the form of software and/or hardware. For example, the apparatus is implemented through an electronic device. The electronic device can be a mobile terminal, a personal computer (PC) end, a server, or the like.

As shown in FIG. 1, the method of this embodiment can include:

S110. In response to a rendering trigger request for an augmented reality image, a three-dimensional model of a linear object corresponding to the augmented reality image is displayed in the augmented reality image.

The augmented reality image is generally an image where a real environment and a virtual object coexist in the same space, namely, an image generated by applying the virtual object to the real environment. In this embodiment of the present disclosure, the virtual object may be a three-dimensional model of a linear object. The linear object may be understood as an object with linear features. The shape of the linear object may include at least one of a straight line, a curve, and a broken line. The representation style of the shape of the linear object can be solid or dashed.

In this embodiment of the present disclosure, the linear object may be a linear special effect object of the augmented reality image. For example, the linear object may be an identifier line used for at least one preset marker and two image objects, or a trajectory line used for identifying a motion trajectory of the preset marker, or a preset linear special effect object, or the like. It should be noted that there may be various representation forms of linear effect objects, such as whips or sticks.

Exemplarily, when a preset marker (e.g. a small ball, a paper plane, or a dart) moving in a real environment is identified, the linear object may be determined based on a motion trajectory of the preset marker. When two preset markers are detected in the augmented reality image, a connecting line between the two preset markers may be used as the linear object. Alternatively, the rendering trigger request may be analyzed to obtain object shape information (e.g. a straight line shape) used for describing the linear object corresponding to the augmented reality image. Thus, the linear object corresponding to the object shape information described in the rendering trigger request according to a correspondence relationship between the preset linear object and the object shape information.

In this embodiment of the present disclosure, the three-dimensional model of the linear object may be understood as a rendering model used for characterizing three-dimensional features of the linear object, such as a straight-line three-dimensional model, a curved-line three-dimensional model, or a broken-line three-dimensional model. The type of the three-dimensional model of the linear object may be either a mesh type or a point cloud type. Namely, the three-dimensional model of the linear object may be a three-dimensional mesh model of the linear object, or a three-dimensional point cloud model of the linear object. The rendering trigger request can be understood as a trigger request used for displaying the three-dimensional model of the linear object corresponding to the augmented reality image in the augmented reality image.

Considering a display form and underlying rendering logic of the linear object, there may be one, two, or more three-dimensional models of the linear object corresponding to the augmented reality image.

In an embodiment, after the rendering trigger request for the augmented reality image is received, the three-dimensional model of the linear object corresponding to the augmented reality image may be obtained based on the rendering trigger request from a database used for storing three-dimensional models. Namely, the three-dimensional model of the linear object corresponding to the augmented reality image may be read from the database used for storing three-dimensional models and loaded into an internal memory. After the loading is completed, the three-dimensional model of the linear object may be rendered. Thus, the three-dimensional model of the linear object is displayed in the augmented reality image, thereby improving the image quality of the augmented reality image. For example, the database used for storing three-dimensional models may be a local database or a remote database.

In another embodiment, after the rendering trigger request for the augmented reality image is received, the three-dimensional model of the linear object corresponding to the augmented reality image may be constructed based on the rendering trigger request. After the model construction is completed, the three-dimensional model of the linear object can be rendered. Thus, the three-dimensional model of the linear object is displayed in the augmented reality image. For example, the three-dimensional model of the linear object corresponding to the augmented reality image is constructed based on the rendering trigger request, which includes: The rendering trigger request is analyzed, so that model feature data of the three-dimensional model of the linear object displayed in the augmented reality image can be obtained. Thus, the three-dimensional model of the linear object corresponding to the augmented reality image can be constructed based on the model feature data. The advantage of this setting is that the three-dimensional model of the linear object displayed in augmented reality image may be dynamically drawn based on a personalized need.

In this embodiment of the present disclosure, a mode for obtaining a rendering trigger request may be receiving a triggering operation for triggering rendering of the augmented reality image, and generating, based on the triggering operation, the rendering trigger request for the augmented reality image. It should be noted that the triggering operation for triggering the rendering of the augmented reality image has various triggering modes. Exemplarily, the triggering operation for triggering the rendering of the augmented reality image can be a triggering operation applied to a triggering control used for triggering the rendering of the augmented reality image; or a triggering operation generated based on an acquired voice command for rendering the augmented reality image; or a triggering operation generated based on acquired image information for rendering the augmented reality image.

The triggering control may include a physical triggering control and/or a virtual triggering control. The physical triggering control can be an entity control, such as a push button and a slide button. The virtual triggering control may be a control displayed on a touch screen and used for triggering the rendering of the augmented reality image. It should be noted that an icon style, display effect, and display position of the virtual triggering control can be set according to an actual need, and will not be limited here. For example, a triggering operation for triggering rendering of the augmented reality image is received, and it may be a triggering operation (e.g. clicking or push button) applied to a triggering control for triggering the rendering of the augmented reality image.

In this embodiment of the present disclosure, there are various modes for rendering the three-dimensional model of the linear object, and will not be limited here.

As an alternative implementation of this embodiment of the present disclosure, the three-dimensional model of the linear object is rendered, which may include: The rendering trigger request is analyzed, so that rendering parameters for the three-dimensional model of the linear object can be obtained. Thus, the three-dimensional model of the linear object can be rendered based on the rendering parameters. The rendering parameters may include a material, lighting, textures, and the like.

As another alternative implementation of this embodiment of the present disclosure, the three-dimensional model of the linear object is rendered, and it may include: after the rendering trigger request for the augmented reality image is received, rendering parameters corresponding to the three-dimensional model of the linear object are read from pre-configured rendering parameter information based on the rendering trigger request. The three-dimensional model of the linear object is rendered based on the rendering parameters.

S120. In response to a display adjustment operation for the linear object, an adjusted three-dimensional model of the linear object is displayed in the augmented reality image.

The display adjustment operation can be understood as an operation for adjusting the linear object displayed in the augmented reality image. There are various modes for performing the display adjustment operation. Exemplarily, the display adjustment operation may be a touch operation applied to the linear object displayed in the augmented reality image, such as a single-click operation, a sliding operation, or a double-click operation; or a click operation applied to a control used for adjusting the linear object displayed in augmented reality image; or a push operation applied to an entity button used for adjusting the linear object displayed in the augmented reality image. The display adjustment operation may include a display position adjustment operation, a display size adjustment operation, and/or a display angle adjustment operation. In this embodiment of the present disclosure, based on the display adjustment operation, the displaying of the linear object can be adjusted to better meet the personalized need of a user. Furthermore, the three-dimensional model of the linear object may be displayed in all directions and in multiple angles, which enriches augmented reality images.

In this embodiment of the present disclosure, the display adjustment operation can be understood as an operation for adjusting a position of the linear object displayed in the augmented reality image. In other words, the linear object displayed at a current display position in the augmented reality image is adjusted from the current display position to a target display position in the augmented reality image. The target display position may be understood as a display position obtained by moving the linear object displayed in the augmented reality image in a direction based on the current position of the linear object. The direction may include moving to the left, right, up, and down. Exemplarily, the linear object displayed in a lower left corner of the augmented reality image can be adjusted from the lower left corner to an upper left corner of the augmented reality image.

The display size adjustment operation may be understood as an operation for adjusting a size of the linear object displayed in the augmented reality image, namely, adjusting the linear object with a current display size displayed in the augmented reality image from the current display size to a target display size. The display target size may be understood as a size obtained by scaling up or scaling down the linear object displayed in the augmented reality image. The display angle adjustment operation can be understood as an operation for adjusting an angle of the linear object displayed in augmented reality image. In other words, the linear object displayed in a current display angle in the augmented reality image is adjusted from the current display angle to a target display angle, so that the linear object is displayed in the target display angle in the augmented reality image. The target display angle may be understood as an angle obtained by adjusting the display angle of the linear object displayed in the current display angle in the augmented reality image.

In an embodiment, after the display position adjustment operation for the linear object is received, display position operation information of the display position adjustment operation may be obtained. Thus, based on the display position operation information, the target display position for displaying the three-dimensional model of the linear object in the augmented reality image can be determined. Thus, the three-dimensional model of the linear object may be rendered based on the display position. Thus, the three-dimensional model of the linear object is displayed at the target display position in the augmented reality image.

In another embodiment, after the display angle adjustment operation for the linear object is received, display angle operation information of the display angle adjustment operation can be obtained. Thus, a rotation angle and rotation axis of the display angle operation for the three-dimensional model of the linear object may be determined based on the display angle operation information. Thus, the target display angle of the three-dimensional model of the linear object may be determined based on the rotation axis and the rotation angle. Thus, the three-dimensional model of the linear object may be displayed in the target display angle in the augmented reality image.

In an embodiment, after the display size adjustment operation for the linear object is received, display size operation information of the display size adjustment operation can be obtained. Thus, the three-dimensional model of the linear object may be reconstructed based on the display size operation information. Thus, a reconstructed three-dimensional model of the linear object may be obtained. The reconstructed three-dimensional model of the linear object may be rendered into the augmented reality image. Thus, the reconstructed three-dimensional model of the linear object is displayed in the augmented reality image.

It should be noted that there are various modes for reconstructing the three-dimensional model of the linear object in this embodiment of the present disclosure. As an alternative implementation of this embodiment of the present disclosure, the reconstruction may include determining a target display size for displaying the three-dimensional model of the linear object in the augmented reality image based on the display size operation information; and reconstructing the three-dimensional model of the linear object based on the target display size.

As another alternative implementation of this embodiment of the present disclosure, the following may be included: A current display size of the three-dimensional model of the linear object is determined; and a size ratio relative to the current display size is obtained based on the display size operation information. Thus, a target display size for displaying the three-dimensional model of the linear object in the augmented reality image may be obtained based on the size ratio and the current display size. Thus, the three-dimensional model of the linear object with the target display size is displayed in the augmented reality image.

In this embodiment of the present disclosure, in response to a rendering trigger request for an augmented reality image, a three-dimensional model of a linear object corresponding to the augmented reality image is displayed in the augmented reality image, which can enhance the stereo perception and third dimension of the linear object in the augmented reality image. In response to a display adjustment operation for the linear object, an adjusted three-dimensional model of the linear object is displayed in the augmented reality image. The display adjustment operation includes a display position adjustment operation, a display size adjustment operation, and/or a display angle adjustment operation. In this embodiment of the present disclosure, the three-dimensional model of the linear object is displayed in the augmented reality image, which not only realistically integrates the linear object into the augmented reality image, but also effectively implements interaction with the linear object according to the personalized need of a user, thereby enhancing the user experience.

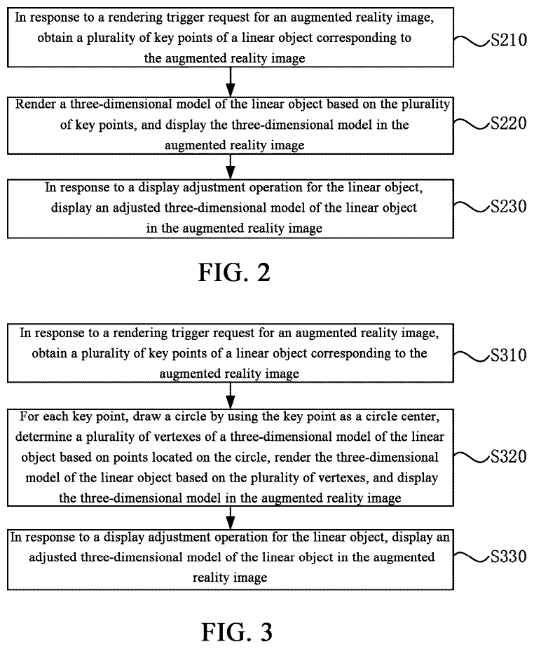

FIG. 2 is a flowchart of a method for augmented reality image processing according to an embodiment of the present disclosure. Based on the above embodiment, this embodiment exemplarily describes how to display a three-dimensional model of a linear object in an augmented reality image. For example, a three-dimensional model of a linear object corresponding to the augmented reality image is displayed in the augmented reality image, and it includes: a plurality of key points of the linear object corresponding to the augmented reality image are obtained; and the three-dimensional model of the linear object is rendered based on the plurality of key points, and the three-dimensional model is displayed in the augmented reality image. The specific implementation may be found in the description of this embodiment. Technical features that are the same or similar to those in the previous embodiment will not be elaborated here.

As shown in FIG. 2, the method of this embodiment can include:

S210. In response to a rendering trigger request for an augmented reality image, a plurality of key points of a linear object corresponding to the augmented reality image are obtained.

The key points of the linear object may be understood as feature points of the linear object. The plurality of key points of the linear object can depict the shape of the linear object, such as a straight line, a curved line, or a broken line. To more accurately reflect the position of each key point of the linear object, a coordinate system can be constructed in advance, so that position information of each key point of the linear object can be represented using a coordinate points in the coordinate system.

For example, after the rendering trigger request for the augmented reality image is received, the linear object corresponding to the augmented reality image may be determined based on the rendering trigger request. Thus, the plurality of key points of the linear object may be obtained.

In this embodiment of the present disclosure, there are various modes for obtaining the plurality of key points of linear objects corresponding to the augmented reality image.

As an alternative implementation of this embodiment of the present disclosure, a plurality of key points of the linear objects corresponding to the augmented reality image are obtained, and it may include: the plurality of key points of the linear object corresponding to the augmented reality image are generated based on a preset algorithm. The preset algorithm can be a preset algorithm used for generating key points.

For example, the plurality of key points of the linear object corresponding to the augmented reality image are generated based on a preset algorithm, and it may include: The plurality of key points of the linear object corresponding to the augmented reality image are randomly generated based on the preset algorithm; or, after the rendering trigger request for the augmented reality image is received, the rendering trigger request can be analyzed. Thus, a preset drawing frame rate of the key points of the linear object corresponding to the augmented reality image can be obtained. Therefore, the plurality of key points of the linear object corresponding to the augmented reality image are generated based on the preset drawing frame rate and the preset algorithm,

As another alternative implementation of this embodiment of the present disclosure, a plurality of key points of the linear object corresponding to the augmented reality image are obtained, and it may include: An associated object of a linear object to be rendered in the augmented reality image is determined, and the plurality of key points of the linear object corresponding to the augmented reality image are determined based on a motion trajectory of the associated object. The linear object to be rendered can be understood as a linear object that needs to be rendered in the augmented reality image. The associated object may be understood as an object, having an association relationship with the linear object to be rendered, in augmented reality image. Exemplarily, the associated object that has the association relationship with the linear object to be rendered may be a paper plane displayed in the augmented reality image. The linear object to be rendered can be a flight trajectory of the paper plane displayed in the augmented reality image.

For example, the associated object, having the association relationship with the linear object to be rendered, in the augmented reality image is determined. After the associated object is determined, the motion trajectory of the associated object can be obtained. After the motion trajectory is obtained, feature extraction may be performed on the motion trajectory. Thus, a plurality of feature points of the motion trajectory may be obtained, and the extracted feature points may be used as the plurality of key points of the linear object corresponding to the augmented reality image.

Exemplarily, the associated object of the linear object to be rendered may be a flying plane displayed in the augmented reality image. The linear object to be rendered may be a motion trajectory of one or more positions on the plane flying in the augmented reality image. The plurality of key points of the linear object to be rendered can be understood as the feature points of the motion trajectory of a position on the plane flying in the augmented reality image.

As an alternative implementation of the present disclosure, a plurality of key points of a linear object corresponding to the augmented reality image are obtained, and it includes a shape of the linear object corresponding to the augmented reality image is determined. Thus, the plurality of key points of the linear object can be obtained according to the shape of the linear object. For example, the plurality of key points of the linear object can be obtained according to the shape of the linear object, and it may include: key points corresponding to the shape are obtained based on the shape of the linear object from a database used for storing key points of the linear object; or, the key points of the linear object are generated based on the shape of the linear object.

S220. A three-dimensional model of the linear object is rendered based on the plurality of key points, and the three-dimensional model is displayed in the augmented reality image.

For example, after the plurality of key points of the linear object are obtained, the three-dimensional model of the linear object corresponding to the plurality of key points can be obtained. Thus, the three-dimensional model can be rendered into the augmented reality image, and the three-dimensional model is displayed in the augmented reality image.

In this embodiment of the present disclosure, there are various modes for obtaining the three-dimensional model of the linear object corresponding to the plurality of key points.

As an alternative implementation of this embodiment of the present disclosure, the plurality of key points can be fitted, thus, obtaining a fitting result. Model reconstruction may be performed based on the fitting result. Thus, the three-dimensional model of the linear object corresponding to the plurality of key points can be obtained, which has the advantage that the three-dimensional model of the linear object can be drawn according to a personalized need.

As another alternative implementation of the present disclosure, a three-dimensional model matched with the plurality of key points can be matched from a database used for storing three-dimensional models, and the matched three-dimensional model can be used as the three-dimensional model of the linear object corresponding to the plurality of key points. The advantage is that the three-dimensional model of the linear object can be obtained more quickly and effectively, thereby improving the response speed to the rendering trigger request for the augmented reality image.

S230. In response to a display adjustment operation for the linear object, an adjusted three-dimensional model of the linear object is displayed in the augmented reality image.

In this embodiment of the present disclosure, a plurality of key points of a linear object corresponding to an augmented reality image are obtained; a three-dimensional model of the linear object is rendered based on the plurality of key points; and the three-dimensional model is displayed in the augmented reality image, so that the three-dimensional model of the linear object can be obtained in a targeted manner, and the augmented reality image is enriched.

FIG. 3 is a flowchart of a method for augmented reality image processing according to an embodiment of the present disclosure. Based on the above embodiment, this embodiment exemplarily describes how to render a three-dimensional model of a linear object based on a plurality of key points. For example, the three-dimensional model of the linear object is rendered based on the plurality of key points, and it includes for each key point, a circle is drawn by using the key point as a circle center, a plurality of vertexes of the three-dimensional model of the linear object are determined based on points located on the circle, and the three-dimensional model of the linear object is rendered based on the plurality of vertexes. The specific implementation may be found in the description of this embodiment. Technical features that are the same or similar to those in the previous embodiment will not be elaborated here.

As shown in FIG. 3, the method of this embodiment may include:

S310. In response to a rendering trigger request for an augmented reality image, a plurality of key points of a linear object corresponding to the augmented reality image are obtained.

S320. For each key point, a circle is drawn by using the key point as a circle center, a plurality of vertexes of a three-dimensional model of the linear object are determined based on points located on the circle; the three-dimensional model of the linear object is rendered based on the plurality of vertexes; and the three-dimensional model is displayed in the augmented reality image.

For example, a circle is drawn by using the key point as a circle center, which may include: A preset circle radius corresponding to the key point is obtained. The key point is used as the circle center. The circle is drawn based on the preset circle radius corresponding to the key point and the circle center. The preset circle radius may be understood as a radius preset for each key point for drawing a circle. It should be noted that the preset circle radiuses corresponding to the various key points can be the same or different. For example, a preset circle radius corresponding to the key point is obtained, which may include the rendering trigger request is analyzed to obtain the preset circle radius corresponding to each key point included in the rendering trigger request; or, circle radius configuration information configured for the plurality of key points is obtained, and the circle radius configuration information includes the preset circle radius of each key point; and the preset circle radius corresponding to the key point is matched according to the circle radius configuration information.

In this embodiment of the present disclosure, there are various modes for determining the plurality of vertexes of the three-dimensional model of the linear object based on the points located on the circle.

As an alternative implementation of this embodiment of the disclosure, any diameter of the circle is drawn using the circle center; and the diameter is rotated at a preset rotation angle (e.g. 5 degrees, 10 degrees, or 15 degrees). During the rotation, intersection points of the diameter and the circle are determined, and the various intersection points are used as the plurality of vertexes of the three-dimensional model of the linear object.

As another alternative implementation of this embodiment of the present disclosure, any point is selected from the circle. The selected point is used as a fixed point, and a plurality of straight lines are drawn with reference to the fixed point. Intersection points of the various straight lines and the circle are used as the plurality of vertexes of the three-dimensional model of the linear object.

In this embodiment of the present disclosure, a three-dimensional model of the linear object is rendered based on the plurality of vertexes, and the three-dimensional model is displayed in the augmented reality image, which may include: Curve fitting is performed on the plurality of vertexes to fit the various vertexes into a curved line. Thus, a plurality of curve lines can be obtained. After the plurality of curved lines are obtained, the various curved lines can be constructed into a curved surface based on a preset curved surface construction mode, thereby obtaining a plurality of curved surfaces. After the plurality of curved surfaces are obtained, the three-dimensional model of the linear object may be constructed based on the various curved surfaces. After the three-dimensional model is constructed, the three-dimensional model may be rendered based on rendering information (e.g. texture, material, sticker, lighting, and model skeleton actions) related to the three-dimensional model. After the rendering is completed, the rendered three-dimensional model is displayed in the augmented reality image.

S330. In response to a display adjustment operation for the linear object, an adjusted three-dimensional model of the linear object is displayed in the augmented reality image.

In this embodiment of the present disclosure, for each key point, a circle is drawn by using the key point as a circle center; a plurality of vertexes of the three-dimensional model of the linear object are determined based on points located on the circle; and the three-dimensional model of the linear object is rendered based on the plurality of vertexes, so that dynamic construction of the three-dimensional model of the linear object can be achieved.

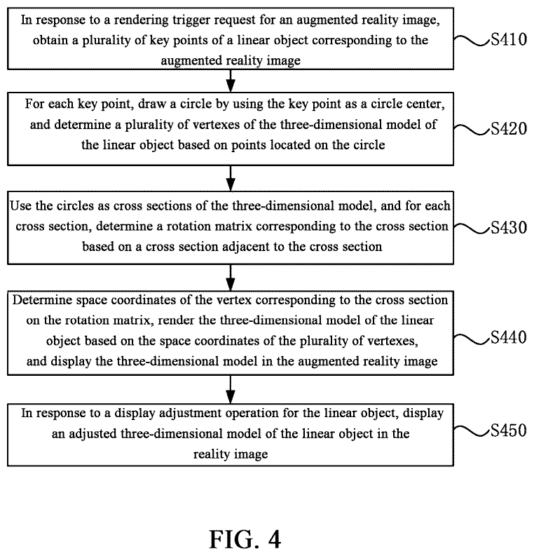

FIG. 4 is a flowchart of a method for augmented reality image processing according to an embodiment of the present disclosure. Based on the above embodiment, this embodiment exemplarily describes how to render a three-dimensional model of a linear object based on a plurality of vertexes. For example, the three-dimensional model of the linear object is rendered based on the plurality of vertexes, which includes: The circles are used as cross sections of the three-dimensional model, and for each cross section, a rotation matrix corresponding to the cross section is determined based on a cross section adjacent to the cross section; and space coordinates of the vertex corresponding to the cross section is determined based on the rotation matrix, and the three-dimensional model of the linear object is rendered based on the space coordinates of the plurality of vertexes. The specific implementation can be found in the description of this embodiment. Technical features that are the same or similar to those in the previous embodiment will not be elaborated here.

As shown in FIG. 4, the method of this embodiment can include:

S410. In response to a rendering trigger request for an augmented reality image, a plurality of key points of a linear object corresponding to the augmented reality image are obtained.

S420. For each key point, a circle is drawn by using the key point as a circle center; and a plurality of vertexes of the three-dimensional model of the linear object are determined based on points located on the circle.

S430. The circles are used as cross sections of the three-dimensional model, and for each cross section, a rotation matrix corresponding to the cross section is determined based on a cross section adjacent to the cross section.

In this embodiment of the present disclosure, a rotation matrix corresponding to the cross section is determined based on a cross section adjacent to the cross section, which includes: A vector between the circle center of the cross section and the circle center of the cross section adjacent to the cross section is used as a reference vector, and the rotation matrix corresponding to the cross section is calculated according to a horizontal direction vector and the reference vector.

The reference vector can be understood as a directed line segment between the circle center of the cross section and the circle center of the cross section adjacent to the cross section. The directed line segment between the circle center of the cross section and the circle center of the cross section adjacent to the cross section can be a directed line segment pointing from the circle center of the cross section to the circle center of the cross section adjacent to the cross section, or a directed line segment pointing from the circle center of the cross section adjacent to the cross section to the circle center of the cross section. The horizontal direction vector may be understood as any vector parallel to an X-axis in a three-dimensional coordinate system. In other words, the horizontal direction vector can be understood as any vector perpendicular to a YZ plane in the three-dimensional coordinate system. The YZ plane is a plane composed of a Y-axis and a Z-axis.

In this embodiment of the present disclosure, the rotation matrix corresponding to the cross section is calculated based on a horizontal direction vector and the reference vector, and it may include: The horizontal direction vector and the reference vector are used as actual parameters, and are transmitted to pre-defined entrance parameters of a rotation matrix method for calculating the rotation matrix corresponding to the cross section. After the parameter transmission is completed, the rotation matrix method is performed. Thus, the rotation matrix corresponding to the cross section may be calculated.

For example, the horizontal direction vector and the reference vector are substituted into a dot product formula for calculation, so that a rotation angle between the horizontal direction vector and the reference vector is obtained. Thus, a rotation axis of the cross section and the cross section adjacent to the cross section can be determined based on the rotation angle. The rotation matrix corresponding to the cross section can be calculated based on the rotation angle, the rotation axis, and the Rodrigues rotation formula.

S440. Space coordinates of the vertex corresponding to the cross section are determined based on the rotation matrix; the three-dimensional model of the linear object is rendered based on the space coordinates of the plurality of vertexes; and the three-dimensional model is displayed in the augmented reality image.

In this embodiment of the present disclosure, space coordinates of the vertex corresponding to the cross section are determined based on the rotation matrix, which may include: Space coordinates of the vertex corresponding to the cross section adjacent to the cross section may be determined; and the space coordinates of the vertex corresponding to the cross section may be then determined based on the space coordinates of the vertex corresponding to the cross section adjacent to the cross section and the rotation matrix. The advantage of this setting is that a rotation orientation posture of the cross section may be corrected through the rotation matrix of the cross section.

For example, the space coordinates of the vertex corresponding to the cross section are determined based on the space coordinates of the vertex corresponding to the cross section adjacent to the cross section and the rotation matrix, and it includes a coordinate matrix of the vertex corresponding to the cross section adjacent to the cross section may be constructed according to the space coordinates of the vertex corresponding to the cross section adjacent to the cross section. Thus, the coordinate matrix of the vertex can be leftwards multiplied by the rotation matrix for matrix calculation. Therefore, the space coordinates of the vertex corresponding to the cross section may be determined based on a matrix calculation result.

S450. In response to a display adjustment operation for the linear object, an adjusted three-dimensional model of the linear object is displayed in the augmented reality image.

In this embodiment, the circle is used as a cross section of the three-dimensional model; for each cross section, a rotation matrix corresponding to the cross section is determined based on a cross section adjacent to the cross section; space coordinates of the vertex corresponding to the cross section is determined based on the rotation matrix; and the three-dimensional model of the linear object is rendered based on the space coordinates of the plurality of vertexes, so that the three-dimensional model of the linear object may be constructed more efficiently and accurately.

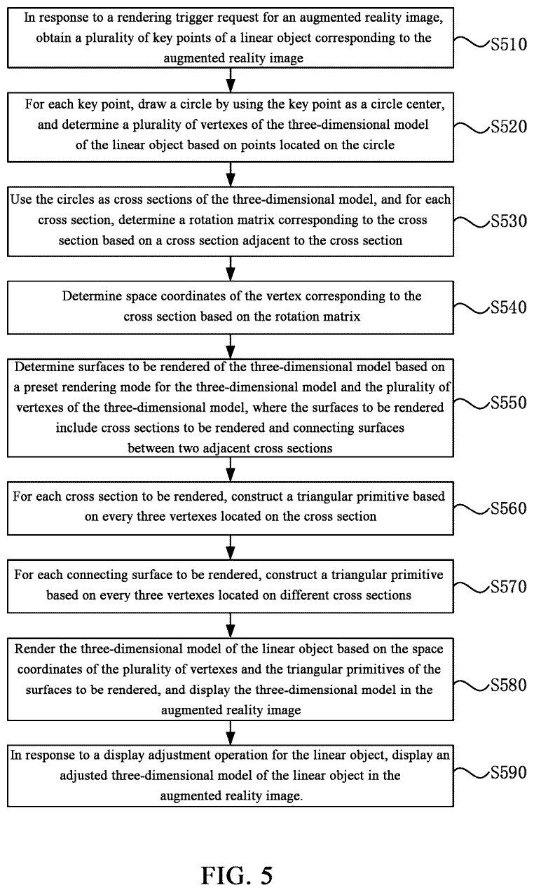

FIG. 5 is a flowchart of a method for augmented reality image processing according to an embodiment of the present disclosure. Based on the above embodiment, this embodiment exemplarily describes how to render a three-dimensional model of a linear object based on space coordinates of a plurality of vertexes. For example, the three-dimensional model of the linear object is rendered based on the space coordinates of the plurality of vertexes, which includes: Surfaces to be rendered of the three-dimensional model are determined based on a preset rendering mode for the three-dimensional model and the plurality of vertexes of the three-dimensional model, wherein the surfaces to be rendered includes cross sections to be rendered and connecting surfaces between two adjacent cross sections; for each cross section to be rendered, a triangular primitive is constructed based on every three vertexes located on the cross section; for each connecting surface to be rendered, a triangular primitive is constructed based on every three vertexes located on different cross sections; and the three-dimensional model of the linear object is rendered based on the space coordinates of the plurality of vertexes and the triangular primitives of the surfaces to be rendered. The specific implementation may be found in the description of this embodiment. Technical features that are the same or similar to those in the previous embodiment will not be elaborated here.

As shown in FIG. 5, the method of this embodiment can include:

S510. In response to a rendering trigger request for an augmented reality image, a plurality of key points of a linear object corresponding to the augmented reality image are obtained.

S520. For each key point, a circle is drawn by using the key point as a circle center; and a plurality of vertexes of the three-dimensional model of the linear object are determined based on points located on the circle.

S530. The circles are used as cross sections of the three-dimensional model, and for each cross section, a rotation matrix corresponding to the cross section is determined based on a cross section adjacent to the cross section.

S540. Space coordinates of the vertex corresponding to the cross section are determined based on the rotation matrix.

S550. Surfaces to be rendered of the three-dimensional model are determined based on a preset rendering mode for the three-dimensional model and the plurality of vertexes of the three-dimensional model. The surfaces to be rendered include cross sections to be rendered and connecting surfaces between two adjacent cross sections.

The preset rendering mode may be understood as a preset rendering mode for the plurality of vertexes of the three-dimensional model, which may include continuous rendering and/or intermittent rendering. The continuous rendering may be used for rendering a linear object with a solid line representation style. The intermittent rendering may be used for rendering as linear object with a dashed line representation style. The surfaces to be rendered can be understood as surfaces that need to be rendered in the three-dimensional model. The surfaces to be rendered may include at least two cross sections to be rendered and connecting surfaces between two adjacent cross sections. Exemplarily, the three-dimensional model of the linear object may be a cylindrical model, and the cross sections to be rendered may be two bottom surfaces of the cylindrical model. The connecting surfaces between two adjacent cross sections may be side surfaces located between the two bottom surfaces of the cylindrical model.

In an embodiment, surfaces to be rendered of the three-dimensional model are determined based on a preset rendering mode for the three-dimensional model and the plurality of vertexes of the three-dimensional model, which may include: In responding to the preset rendering mode for the three-dimensional model being continuous rendering, a start cross section and an end cross section of the three-dimensional model can be used as the cross sections to be rendered, and the connecting surfaces between every two adjacent cross sections are used as connecting surfaces to be rendered. The start cross section can be understood as the first cross section constructed during the construction of the three-dimensional model. The end cross section may be understood as the last cross section constructed during the construction of the three-dimensional model.

In another embodiment, surfaces to be rendered of the three-dimensional model are determined based on a preset rendering mode for the three-dimensional model and the plurality of vertexes of the three-dimensional model, and it may include in responding to the preset rendering mode for the three-dimensional model being intermittent rendering, a start cross section, an end cross section, and at least two cross sections, except the start cross section and the end cross section, of the three-dimensional model are used as the cross sections to be rendered, and connecting surfaces to be rendered are determined based on the cross sections to be rendered, to achieve intermittent displaying of the connecting surfaces.

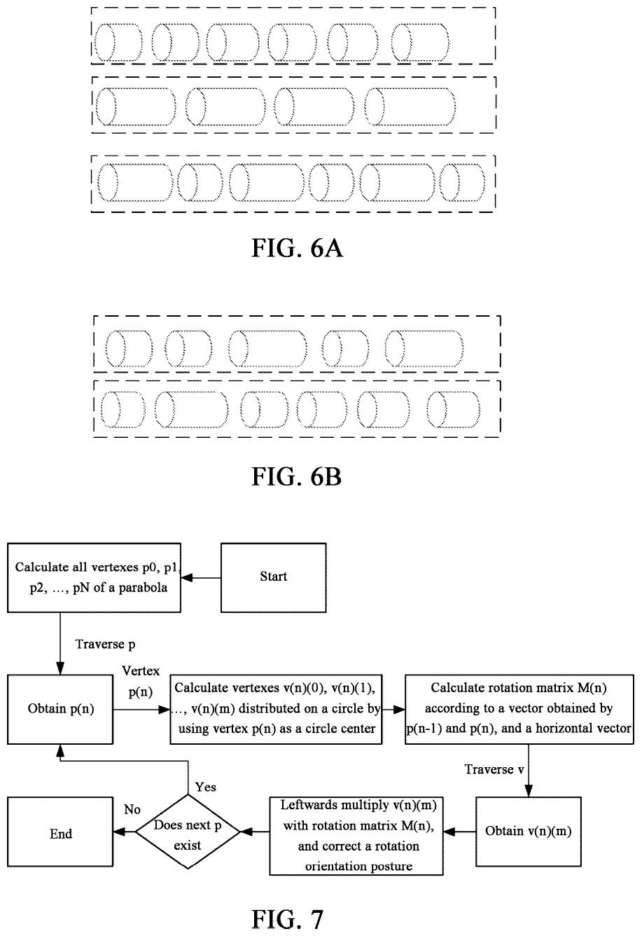

In this embodiment of the present disclosure, whether a cross section is a cross section to be rendered can be determined based on an arrangement serial number of the cross section. There are various modes for determining, according to an arrangement serial number of a cross section, whether the cross section is a cross section to be rendered. For example, cross sections with odd arrangement serial numbers can be used as the cross sections to be rendered. Or, cross sections with even arrangement serial numbers can be used as the cross sections to be rendered. It should be noted that the intermittent rendering can be either regular intermittent rendering (see FIG. 6A) or irregular intermittent rendering (see FIG. 6B).

S560. For each cross section to be rendered, a triangular primitive is constructed based on every three vertexes located on the cross section.

The triangular primitive can be understood as a triangular patch. For example, for each cross section to be rendered, all the vertexes of the cross section to be rendered can be determined. A preset model patch construction algorithm (e.g. a region generation algorithm) can be used to draw connecting lines for every three of all the vertexes located on the cross section, thereby constructing the triangular primitive.

S570. For each connecting surface to be rendered, a triangular primitive is constructed based on every three vertexes located on different cross sections.

For example, for each connecting surface to be rendered, all the vertexes of the connecting surface to be rendered can be determined. A preset model patch construction algorithm can be used to draw connecting lines for every three of all the vertexes located on the connecting, thereby constructing the triangular primitive.

S580. The three-dimensional model of the linear object is rendered based on the space coordinates of the plurality of vertexes and the triangular primitives of the surfaces to be rendered, and the three-dimensional model is displayed in the augmented reality image.

In this embodiment of the present disclosure, the three-dimensional model of the linear object may be generated based on the space coordinates of the plurality of vertexes and the triangular primitives of the surfaces to be rendered. After the three-dimensional model is generated, the three-dimensional model may be rendered based on rendering parameters of the three-dimensional model. After the rendering is completed, the rendered three-dimensional model is displayed in the augmented reality image.

To improve the realism of the three-dimensional model in the augmented reality image, after the three-dimensional model of the linear object is generated, the triangular primitives in the three-dimensional model may be refined based on model refinement parameters set for the three-dimensional model. The refinement parameters may include shapes of the patches, a size of a single patch, tension between adjacent patches, and the like.

S590. In response to a display adjustment operation for the linear object, an adjusted three-dimensional model of the linear object is displayed in the augmented reality image.

In this embodiment of the present disclosure, the three-dimensional model of the linear object is rendered based on the space coordinates of the plurality of vertexes, which includes: Surfaces to be rendered of the three-dimensional model are determined based on a preset rendering mode for the three-dimensional model and the plurality of vertexes of the three-dimensional model, wherein the surfaces to be rendered includes cross sections to be rendered and connecting surfaces between two adjacent cross sections; for each cross section to be rendered, a triangular primitive is constructed based on every three vertexes located on the cross section; for each connecting surface to be rendered, a triangular primitive is constructed based on every three vertexes located on different cross sections; and the three-dimensional model of the linear object is rendered based on the space coordinates of the plurality of vertexes and the triangular primitives of the surfaces to be rendered, so that the three-dimensional model of the linear object is rendered by various modes, thereby obtaining various display forms of the three-dimensional model of the linear object and enriching content in the augmented reality image.

The embodiments of the present disclosure provide an example of a method for augmented reality image processing. In this embodiment of the present disclosure, a motion trajectory of a moving object is used as a linear object, and the motion trajectory of the moving object can be a parabola, namely, the linear object can be a parabola. The specific implementation can be found in the description of this embodiment. Technical features that are the same or similar to those in the previous embodiment will not be elaborated here.

As shown in FIG. 7, after a rendering trigger request for an augmented reality image is received, a plurality of key points of a parabola corresponding to the augmented reality image may be obtained (P0, P1, P2, . . . , PN in FIG. 7).

Exemplarily, a plurality of key points of a parabola corresponding to the augmented reality image are obtained, which may include: An initial velocity vector V of the moving object, initial coordinates P (x0, y0), and a gravitational acceleration g are obtained. A frame rate for drawing trajectory points of the motion of the moving object can be f. Components of the initial velocity vector V on an x-axis and a z-axis can be merged into a horizontal component Vx, and a vertical direction can be separately used as a vector Vy. A height in the vertical direction can be calculated every 1/f of a horizontal distance according to the frame rate for drawing. An increment of virtual time t may be 1/f.

A height y of the moving object in the vertical direction can be calculated using the following formula:

$$y = y 0 + Vy * t + 1 / 2 * g * {t}^{2}$$

A distance x of the moving object in the horizontal direction may be calculated according to the following formula:

$$x = x 0 + Vx * t$$

After the calculation is completed, the horizontal distance can be decomposed into an x-axis distance and a z-axis distance according to the initial velocity V. Thus, a plurality of trajectory points of the moving object can be obtained, namely, a plurality of key points of the parabola.

For each key point, a circle is drawn using a key point (P(n) in FIG. 7) as a circle center; a plurality of vertexes (v(n)(0), v(n)(1), . . . v(n)(m) in FIG. 7) of the three-dimensional model of the linear object are determined based on points located on the circle; the circles are used as cross sections of the three-dimensional model; for each cross section, a vector between the circle center of the cross section and the circle center of a cross section adjacent to the cross section are used as a reference vector (a vector obtained by calculating p(n−1) and p(n) in FIG. 7); and a rotation matrix corresponding to the cross section is calculated according to a horizontal direction vector and the reference vector (M(n) in FIG. 7).

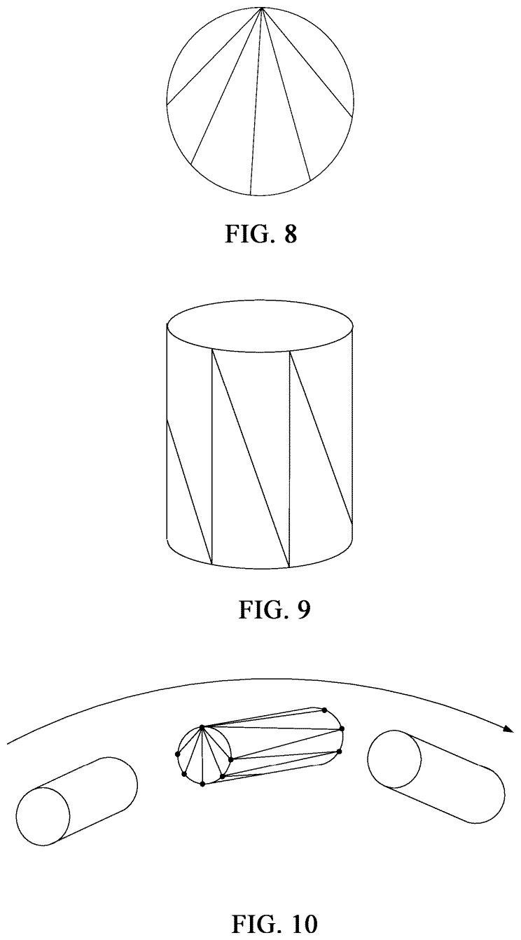

Space coordinates of the vertex corresponding to the cross section are determined based on the rotation matrix. Surfaces to be rendered of the three-dimensional model are determined based on a preset rendering mode for the three-dimensional model and the plurality of vertexes of the three-dimensional model. Each surface to be rendered may include cross sections to be rendered and connecting surfaces between two adjacent cross sections. For each cross section to be rendered, a triangular primitive is constructed based on every three vertexes located on the cross section (see FIG. 8). For each connecting surface to be rendered, a triangular primitive is constructed based on every three vertexes located on different cross sections (see FIG. 9).

For example, in responding to the preset rendering mode for the three-dimensional model of the parabola being intermittent rendering, a start cross section, an end cross section, and at least two cross sections, except the start cross section and the end cross section, of the three-dimensional model of the parabola are used as the cross sections to be rendered, and connecting surfaces to be rendered are determined based on the cross sections to be rendered, to achieve intermittent displaying of the connecting surfaces (see FIG. 10).

The three-dimensional model of the linear object is rendered based on the space coordinates of the plurality of vertexes and the triangular primitives of the surfaces to be rendered, and the three-dimensional model is displayed in the augmented reality image.

In this embodiment of the present disclosure, the three-dimensional model of the linear object is displayed in the augmented reality image, which not only realistically integrates the linear object into the augmented reality image, but also effectively achieves interaction with the linear object according to the personalized need of a user, thereby enhancing the user experience.

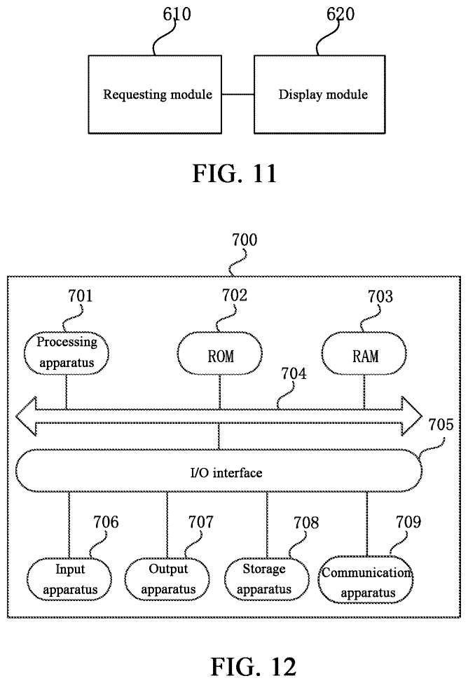

FIG. 11 is a schematic structural diagram of an apparatus for augmented reality image processing according to an embodiment of the present disclosure. As shown in FIG. 11, the apparatus includes: a requesting module 610 and a display module 620.

The requesting module 610 is configured to in response to a rendering trigger request for an augmented reality image, display, in the augmented reality image, a three-dimensional model of a linear object corresponding to the augmented reality image; and the display module 620 is configured to: in response to a display adjustment operation for the three-dimensional model, displaying an adjusted three-dimensional linear object in the augmented reality image, wherein the display adjustment operation includes a display position adjustment operation, a display size adjustment operation, and/or a display angle adjustment operation.

In this embodiment of the present disclosure, in response to a rendering trigger request for an augmented reality image, a three-dimensional model of a linear object corresponding to the augmented reality image is displayed in the augmented reality image, which can enhance the stereo perception and third dimension of the linear object in the augmented reality image. In response to a display adjustment operation for the linear object, an adjusted three-dimensional model of the linear object is displayed in the augmented reality image. The display adjustment operation includes a display position adjustment operation, a display size adjustment operation, and/or a display angle adjustment operation. In this embodiment of the present disclosure, the three-dimensional model of the linear object is displayed in the augmented reality image, which not only realistically integrates the linear object into the augmented reality image, but also effectively achieves interaction with the linear object according to the personalized need of a user, thereby enhancing the user experience.

Based on the various embodiments above, in an embodiment, the requesting module 610 includes a key point obtaining unit and a key point rendering unit.

The key point obtaining unit is configured to obtain a plurality of key points of the linear object corresponding to the augmented reality image; and
the key point rendering unit is configured to render the three-dimensional model of the linear object based on the plurality of key points, and display the three-dimensional model in the augmented reality image.

Based on the various embodiments above, in an embodiment, the key point rendering unit is configured to: for each key point, draw a circle by using the key point as a circle center, determine a plurality of vertexes of the three-dimensional model of the linear object based on points located on the circle, and render the three-dimensional model of the linear object based on the plurality of vertexes.

Based on the various embodiments above, in an embodiment, the key point rendering unit includes a rotation matrix determining subunit and a vertex rendering subunit.

The rotation matrix determining subunit is configured to use the circles as cross sections of the three-dimensional model, and determine, for each cross section, a rotation matrix corresponding to the cross section based on a cross section adjacent to the cross section.

The vertex rendering subunit is configured to: determine, based on the rotation matrix, space coordinates of the vertex corresponding to the cross section, and render the three-dimensional model of the linear object based on the space coordinates of the plurality of vertexes.

Based on the various embodiments above, in an embodiment, the rotation matrix determining subunit is configured to: use a vector between the circle center of the cross section and the circle center of the cross section adjacent to the cross section as a reference vector to calculate the rotation matrix corresponding to the cross section according to a horizontal direction vector and the reference vector.

Based on the various embodiments above, in an embodiment, the vertex rendering subunit is configured to determine surfaces to be rendered of the three-dimensional model based on a preset rendering mode for the three-dimensional model and the plurality of vertexes of the three-dimensional model, wherein the surfaces to be rendered include cross sections to be rendered and connecting surfaces between two adjacent cross sections;
for each cross section to be rendered, construct a triangular primitive based on every three vertexes located on the cross section;
for each connecting surface to be rendered, construct a triangular primitive based on every three vertexes located on different cross sections; and
render the three-dimensional model of the linear object based on the space coordinates of the plurality of vertexes and the triangular primitives of the surfaces to be rendered.

Based on the various embodiments above, in an embodiment, the vertex rendering subunit may be configured to in responding to the preset rendering mode for the three-dimensional model being continuous rendering, use a start cross section and an end cross section of the three-dimensional model as the cross sections to be rendered, and use the connecting surfaces between all adjacent cross sections as connecting surfaces to be rendered.

Based on the various embodiments above, in an embodiment, the vertex rendering subunit may be configured to in responding to the preset rendering mode for the three-dimensional model being intermittent rendering, use a start cross section, an end cross section, and at least two cross sections, except the start cross section and the end cross section, of the three-dimensional model as the cross sections to be rendered, and determine connecting surfaces to be rendered based on the cross sections to be rendered, to achieve intermittent displaying of the connecting surfaces.

Based on the various embodiments above, in an embodiment, the key point obtaining unit is configured to generate the plurality of key points of the linear object corresponding to the augmented reality image based on a preset algorithm; or, determine an associated object of a linear object to be rendered in the augmented reality image, and determine the plurality of key points of the linear object corresponding to the augmented reality image based on a motion trajectory of the associated object.

The apparatus for augmented reality image processing provided according to this embodiment of the present disclosure may implement the method for augmented reality image processing provided in any embodiment of the present disclosure, and includes corresponding functional modules for implementing the method and corresponding beneficial effects.

It is worth noting that the various units and modules included in the above apparatus are only divided according to a functional logic, but are not limited to the above division, as long as the corresponding functions can be achieved. In addition, the names of the various functional units are only for the purpose of distinguishing and are not used to limit the protection scope of the embodiments of the present disclosure.

FIG. 12 is a schematic structural diagram of an electronic device according to the embodiments of the present disclosure. Reference is now made to FIG. 12 below, which illustrates a schematic structural diagram of an electronic device (namely, a terminal device or a server in FIG. 12) 700 suitable for implementing an embodiment of the present disclosure. The terminal device in this embodiment of the present disclosure may include but is not limited to a mobile terminal such as a mobile phone, a laptop, a digital broadcast receiver, a Personal Digital Assistant (PDA), a PAD, a Portable Media Player (PMP), an in-vehicle terminal (such as an in-vehicle navigation terminal), and a fixed terminal such as digital television (TV) and a desktop computer. The electronic device shown in FIG. 12 is only an example and should not impose any limitations on the functionality and scope of use of the embodiments of the present disclosure.

As shown in FIG. 12, the electronic device 700 may include a processing apparatus (such as a central processing unit and graphics processor) 701 that can perform various appropriate actions and processing according to programs stored in a Read-Only Memory (ROM) 702 or loaded from a storage apparatus 708 to a Random Access Memory (RAM) 703. Various programs and data required for operations of the electronic device 700 may also be stored in the RAM 703. The processing apparatus 701, the ROM 702, and the RAM 703 are connected to each other through a bus 704. An Input/Output (I/O) interface 705 is connected to the bus 704 too.

Usually, following apparatuses can be connected to the I/O interface 705: an input apparatus 706 including a touch screen, a touchpad, a keyboard, a mouse, a camera, a microphone, an accelerometer, a gyroscope, and the like; an output apparatus 707 including a Liquid Crystal Display (LCD), a speaker, a vibrator, and the like; a storage apparatus 708 including a magnetic tape, a hard disk drive, and the like; and a communication apparatus 709. The communication apparatus 709 can allow the electronic device 700 to wirelessly or wiredly communicate with other devices to exchange data. Although FIG. 12 shows the electronic device 700 with multiple apparatuses, it should be understood that the electronic device 700 is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present disclosure include a computer program product, including a computer program carried on a non-transitory computer-readable medium, and the computer program includes program codes used for performing the methods shown in the flowcharts. In such an embodiment, the computer program may be downloaded and installed from a network through the communication apparatus 709, or installed from the memory 708, or installed from the ROM 702. When the computer program is executed by the processing apparatus 701, the above-mentioned functions defined in the methods of the embodiments of the present disclosure are executed.

Messages or names of information interacted between a plurality of apparatuses in the implementations of the present disclosure are only for illustrative purposes and are not intended to limit the messages or the scope of the information.

The electronic device provided in this embodiment of the present disclosure and the method for augmented reality image processing provided in the above embodiment belong to the same inventive concept. Technical details not fully described in this embodiment can be found in the above embodiments, and this embodiment has the same beneficial effects as the above embodiments.

The embodiments of the present disclosure provide a computer storage medium having a computer program stored thereon. Running of the program by a processor implements the method for augmented reality image processing provided in the above embodiment.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. Examples of the computer-readable storage media may include, but are not limited to: an electrical connection with one or more wires, a portable computer disk, a hard disk drive, a RAM), a ROM, an Erasable Programmable Read Only Memory (EPROM) or a flash memory, an optical fiber, Compact Disc Read Only Memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but not limited to: a wire, an optical cable, a Radio Frequency (RF), and the like, or any suitable combination of the above.

In some implementations, clients and servers can communicate using any currently known or future developed network protocol such as a HyperText Transfer Protocol (HTTP), and can intercommunicate and be interconnected with digital data in any form or medium (for example, a communication network). Examples of the communication network include a Local Area Network (LAN), a Wide Area Network (WAN), an internet (such as an Internet), a point-to-point network (such as an ad hoc point-to-point network, and any currently known or future developed network.

The computer-readable medium may be included in the electronic device or exist alone and is not assembled into the electronic device.

The computer-readable medium carries one or more programs. When the one or more programs are run by the electronic device, the electronic device is caused to: in response to a rendering trigger request for an augmented reality image, display, in the augmented reality image, a three-dimensional model of a linear object corresponding to the augmented reality image; and in response to a display adjustment operation for the linear object, display an adjusted three-dimensional model of the linear object in the augmented reality image. The display adjustment operation includes a display position adjustment operation, a display size adjustment operation, and/or a display angle adjustment operation.

The storage medium may be a non-transitory storage medium.

Computer program codes for performing the operations of the present disclosure may be written in one or more programming languages or a combination thereof. The above programming languages include but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure can be implemented through software or hardware. The name of the unit does not constitute a limitation on the unit itself. For example, the first obtaining unit can also be described as “a unit that obtains at least two Internet protocol addresses”.

The functions described herein above may be performed, at least in part, by one or a plurality of hardware logic components. For example, non-restrictively, demonstration types of hardware logic components that can be used include: a Field Programmable Gate Array (FPGA), an Application Specific Integrated Circuit (ASIC), an Application Specific Standard Part (ASSP), a System on Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. Examples of the machine-readable medium may include an electrical connection based on one or more wires, a portable computer disk, a hard disk drive, a RAM, a ROM, an EPROM or a flash memory, an optical fiber, a CD-ROM, an optical storage device, a magnetic storage device, or any suitable combinations of the above contents.

According to one or more embodiments of the present disclosure, [Example I] provides a method for augmented reality image processing, including:
in response to a rendering trigger request for an augmented reality image, displaying, in the augmented reality image, a three-dimensional model of a linear object corresponding to the augmented reality image; and
in response to a display adjustment operation for the linear object, displaying an adjusted three-dimensional model of the linear object in the augmented reality image. The display adjustment operation includes a display position adjustment operation, a display size adjustment operation, and/or a display angle adjustment operation.

According to one or more embodiments of the present disclosure, [Example II] provides a method for augmented reality image processing, including:

The displaying, in the augmented reality image, a three-dimensional model of a linear object corresponding to the augmented reality image includes:
obtaining a plurality of key points of the linear object corresponding to the augmented reality image; and
rendering the three-dimensional model of the linear object based on the plurality of key points, and displaying the three-dimensional model in the augmented reality image.

According to one or more embodiments of the present disclosure, [Example III] provides a method for augmented reality image processing, including:
Rendering the three-dimensional model of the linear object based on the plurality of key points includes:
for each key point, drawing a circle by using the key point as a circle center, determining a plurality of vertexes of the three-dimensional model of the linear object based on points located on the circle, and rendering the three-dimensional model of the linear object based on the plurality of vertexes.

According to one or more embodiments of the present disclosure, [Example IV] provides a method for augmented reality image processing, including:
Rendering the three-dimensional model of the linear object based on the plurality of vertexes includes:
using the circles as cross sections of the three-dimensional model, and determining, for each cross section, a rotation matrix corresponding to the cross section based on a cross section adjacent to the cross section; and
determining, based on the rotation matrix, space coordinates of the vertex corresponding to the cross section, and rendering the three-dimensional model of the linear object based on the space coordinates of the plurality of vertexes.

According to one or more embodiments of the present disclosure, [Example V] provides a method for augmented reality image processing, including:
Determining a rotation matrix corresponding to the cross section based on a cross section adjacent to the cross section includes:
using a vector between the circle center of the cross section and the circle center of the cross section adjacent to the cross section as a reference vector to calculate the rotation matrix corresponding to the cross section according to a horizontal direction vector and the reference vector.

According to one or more embodiments of the present disclosure, [Example VI] provides a method for augmented reality image processing, including:
Rendering the three-dimensional model of the linear object based on the space coordinates of the plurality of vertexes includes:
determining surfaces to be rendered of the three-dimensional model based on a preset rendering mode for the three-dimensional model and the plurality of vertexes of the three-dimensional model, wherein the surfaces to be rendered include cross sections to be rendered and connecting surfaces between two adjacent cross sections;
for each cross section to be rendered, constructing a triangular primitive based on every three vertexes located on the cross section;
for each connecting surface to be rendered, constructing a triangular primitive based on every three vertexes located on different cross sections; and
rendering the three-dimensional model of the linear object based on the space coordinates of the plurality of vertexes and the triangular primitives of the surfaces to be rendered.

According to one or more embodiments of the present disclosure, [Example VII] provides a method for augmented reality image processing, including:
Determining surfaces to be rendered of the three-dimensional model based on a preset rendering mode for the three-dimensional model and the plurality of vertexes of the three-dimensional model includes:
in responding to the preset rendering mode for the three-dimensional model being continuous rendering, using a start cross section and an end cross section of the three-dimensional model as the cross sections to be rendered, and using the connecting surfaces between all adjacent cross sections as connecting surfaces to be rendered.

According to one or more embodiments of the present disclosure, [Example VIII] provides a method for augmented reality image processing, including:
Determining surfaces to be rendered of the three-dimensional model based on a preset rendering mode for the three-dimensional model and the plurality of vertexes of the three-dimensional model includes:
in responding to the preset rendering mode for the three-dimensional model being intermittent rendering, using a start cross section, an end cross section, and at least two cross sections, except the start cross section and the end cross section, of the three-dimensional model as the cross sections to be rendered, and determining connecting surfaces to be rendered based on the cross sections to be rendered, to achieve intermittent displaying of the connecting surfaces.

According to one or more embodiments of the present disclosure, [Example IX] provides a method for augmented reality image processing, including:
The obtaining a plurality of key points of the linear object corresponding to the augmented reality image includes:
generating the plurality of key points of the linear object corresponding to the augmented reality image based on a preset algorithm; or,
determining an associated object of a linear object to be rendered in the augmented reality image, and determining the plurality of key points of the linear object corresponding to the augmented reality image based on a motion trajectory of the associated object.

According to one or more embodiments of the present disclosure, [Example X] provides an apparatus for augmented reality image processing, including:
a requesting module, configured to: in response to a rendering trigger request for an augmented reality image, display, in the augmented reality image, a three-dimensional model of a linear object corresponding to the augmented reality image; and
a display module, configured to: in response to a display adjustment operation for the three-dimensional model, displaying an adjusted three-dimensional linear object in the augmented reality image, wherein the display adjustment operation includes a display position adjustment operation, a display size adjustment operation, and/or a display angle adjustment operation.

Those skilled in the art should understand that the scope of disclosure referred to in the present disclosure is not limited to the embodiments formed by specific combinations of the aforementioned technical features, but also covers other embodiments formed by any combinations of the aforementioned technical features or their equivalent features without departing from the concept of the above disclosure, for example, a technical solution formed by replacing the above features with (but not limited to) technical features with similar functions disclosed in the present disclosure.

In addition, although various operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. On the contrary, the specific features and actions described above are only exemplary forms for implementing the claims.

1. A method for augmented reality image processing, comprising:
in response to a rendering trigger request for an augmented reality image, displaying, in the augmented reality image, a three-dimensional model of a linear object corresponding to the augmented reality image; and
in response to a display adjustment operation for the linear object, displaying an adjusted three-dimensional model of the linear object in the augmented reality image, wherein the display adjustment operation comprises at least one of a display position adjustment operation, a display size adjustment operation, or a display angle adjustment operation.

2. The method for augmented reality image processing according to claim 1, wherein displaying, in the augmented reality image, a three-dimensional model of a linear object corresponding to the augmented reality image comprises:
obtaining a plurality of key points of the linear object corresponding to the augmented reality image; and
rendering the three-dimensional model of the linear object based on the plurality of key points, and displaying the three-dimensional model in the augmented reality image.

3. The method for augmented reality image processing according to claim 2, wherein rendering the three-dimensional model of the linear object based on the plurality of key points comprises:
for each key point, drawing a circle by using the key point as a circle center, determining a plurality of vertexes of the three-dimensional model of the linear object based on a point located on the circle, and rendering the three-dimensional model of the linear object based on the plurality of vertexes.

4. The method for augmented reality image processing according to claim 3, wherein rendering the three-dimensional model of the linear object based on the plurality of vertexes comprises:
using the circles as cross sections of the three-dimensional model, and determining, for each cross section, a rotation matrix corresponding to the cross section based on a cross section adjacent to the cross section; and
determining space coordinates of the vertex corresponding to the cross section based on the rotation matrix, and rendering the three-dimensional model of the linear object based on the space coordinates of the plurality of vertexes.

5. The method for augmented reality image processing according to claim 4, wherein determining a rotation matrix corresponding to the cross section based on a cross section adjacent to the cross section comprises:
using a vector between the circle center of the cross section and a circle center of a cross section adjacent to the cross section as a reference vector to calculate the rotation matrix corresponding to the cross section according to a horizontal direction vector and the reference vector.

6. The method for augmented reality image processing according to claim 4, wherein rendering the three-dimensional model of the linear object based on the space coordinates of the plurality of vertexes comprises:
determining surfaces to be rendered of the three-dimensional model based on a preset rendering mode for the three-dimensional model and the plurality of vertexes of the three-dimensional model, wherein the surfaces to be rendered comprise cross sections to be rendered and connecting surfaces between two adjacent cross sections;
for each cross section to be rendered, constructing a triangular primitive based on every three vertexes located on the cross section;
for each connecting surface to be rendered, constructing a triangular primitive based on every three vertexes located on different cross sections; and
rendering the three-dimensional model of the linear object based on the space coordinates of the plurality of vertexes and the triangular primitives of the surfaces to be rendered.

7. The method for augmented reality image processing according to claim 6, wherein determining surfaces to be rendered of the three-dimensional model based on a preset rendering mode for the three-dimensional model and the plurality of vertexes of the three-dimensional model comprises:
in responding to the preset rendering mode for the three-dimensional model being continuous rendering, using a start cross section and an end cross section of the three-dimensional model as the cross sections to be rendered, and using the connecting surfaces between every two adjacent cross sections as connecting surfaces to be rendered, respectively.

8. The method for augmented reality image processing according to claim 6, wherein determining surfaces to be rendered of the three-dimensional model based on a preset rendering mode for the three-dimensional model and the plurality of vertexes of the three-dimensional model comprises:
in responding to the preset rendering mode for the three-dimensional model being intermittent rendering, using a start cross section, an end cross section, and at least two cross sections except the start cross section and the end cross section of the three-dimensional model as the cross sections to be rendered respectively, and determining connecting surfaces to be rendered based on the cross sections to be rendered to cause intermittent displaying of the connecting surfaces.

9. The method for augmented reality image processing according to claim 2, wherein obtaining a plurality of key points of the linear object corresponding to the augmented reality image comprises:
generating the plurality of key points of the linear object corresponding to the augmented reality image based on a preset algorithm; or,
determining an associated object of a linear object to be rendered in the augmented reality image, and determining the plurality of key points of the linear object corresponding to the augmented reality image based on a motion trajectory of the associated object.

10.-18. (canceled)

19. An electronic device, comprising:
one or more processors; and
a storage apparatus, configured to store one or more programs,
wherein the one or more programs, when executed by the one or more processors, cause the one or more processors to:
in response to a rendering trigger request for an augmented reality image, display, in the augmented reality image, a three-dimensional model of a linear object corresponding to the augmented reality image; and
in response to a display adjustment operation for the linear object, display an adjusted three-dimensional model of the linear object in the augmented reality image, wherein the display adjustment operation comprises at least one of a display position adjustment operation, a display size adjustment operation, or a display angle adjustment operation.

20. A non-transitory storage medium comprising computer-executable instructions, wherein when executed by a computer processor, cause the processor to:
in response to a rendering trigger request for an augmented reality image, display, in the augmented reality image, a three-dimensional model of a linear object corresponding to the augmented reality image; and
in response to a display adjustment operation for the linear object, display an adjusted three-dimensional model of the linear object in the augmented reality image, wherein the display adjustment operation comprises at least one of a display position adjustment operation, a display size adjustment operation, or a display angle adjustment operation.

21. The electronic device according to claim 19, wherein the electronic device is further caused to display, in the augmented reality image, a three-dimensional model of a linear object corresponding to the augmented reality image by:
obtaining a plurality of key points of the linear object corresponding to the augmented reality image; and
rendering the three-dimensional model of the linear object based on the plurality of key points, and displaying the three-dimensional model in the augmented reality image.

22. The electronic device according to claim 21, wherein the electronic device is further caused to render the three-dimensional model of the linear object based on the plurality of key points by:
for each key point, drawing a circle by using the key point as a circle center, determining a plurality of vertexes of the three-dimensional model of the linear object based on a point located on the circle, and rendering the three-dimensional model of the linear object based on the plurality of vertexes.

23. The electronic device according to claim 22, wherein the electronic device is further caused to render the three-dimensional model of the linear object based on the plurality of vertexes by:
using the circles as cross sections of the three-dimensional model, and determining, for each cross section, a rotation matrix corresponding to the cross section based on a cross section adjacent to the cross section; and
determining space coordinates of the vertex corresponding to the cross section based on the rotation matrix, and rendering the three-dimensional model of the linear object based on the space coordinates of the plurality of vertexes.

24. The electronic device according to claim 23, wherein the electronic device is further caused to determine a rotation matrix corresponding to the cross section based on a cross section adjacent to the cross section by:
using a vector between the circle center of the cross section and a circle center of a cross section adjacent to the cross section as a reference vector to calculate the rotation matrix corresponding to the cross section according to a horizontal direction vector and the reference vector.

25. The electronic device according to claim 23, wherein the electronic device is further caused to render the three-dimensional model of the linear object based on the space coordinates of the plurality of vertexes by:
determining surfaces to be rendered of the three-dimensional model based on a preset rendering mode for the three-dimensional model and the plurality of vertexes of the three-dimensional model, wherein the surfaces to be rendered comprise cross sections to be rendered and connecting surfaces between two adjacent cross sections;
for each cross section to be rendered, constructing a triangular primitive based on every three vertexes located on the cross section;
for each connecting surface to be rendered, constructing a triangular primitive based on every three vertexes located on different cross sections; and
rendering the three-dimensional model of the linear object based on the space coordinates of the plurality of vertexes and the triangular primitives of the surfaces to be rendered.

26. The electronic device according to claim 25, wherein the electronic device is further caused to determine surfaces to be rendered of the three-dimensional model based on a preset rendering mode for the three-dimensional model and the plurality of vertexes of the three-dimensional model by:
in responding to the preset rendering mode for the three-dimensional model being continuous rendering, using a start cross section and an end cross section of the three-dimensional model as the cross sections to be rendered, and using the connecting surfaces between every two adjacent cross sections as connecting surfaces to be rendered, respectively.

27. The electronic device according to claim 25, wherein the electronic device is further caused to determine surfaces to be rendered of the three-dimensional model based on a preset rendering mode for the three-dimensional model and the plurality of vertexes of the three-dimensional model by:
in responding to the preset rendering mode for the three-dimensional model being intermittent rendering, using a start cross section, an end cross section, and at least two cross sections except the start cross section and the end cross section of the three-dimensional model as the cross sections to be rendered respectively, and determining connecting surfaces to be rendered based on the cross sections to be rendered to cause intermittent displaying of the connecting surfaces.

28. The electronic device according to claim 21, wherein the electronic device is further caused to obtain a plurality of key points of the linear object corresponding to the augmented reality image by:
generating the plurality of key points of the linear object corresponding to the augmented reality image based on a preset algorithm; or,
determining an associated object of a linear object to be rendered in the augmented reality image, and determining the plurality of key points of the linear object corresponding to the augmented reality image based on a motion trajectory of the associated object.

29. The non-transitory storage medium according to claim 20, wherein the processor is further caused to display, in the augmented reality image, a three-dimensional model of a linear object corresponding to the augmented reality image by:
obtaining a plurality of key points of the linear object corresponding to the augmented reality image; and
rendering the three-dimensional model of the linear object based on the plurality of key points, and displaying the three-dimensional model in the augmented reality image.
